(19) United States
(12) Patent Application Publication
(10) Pub. No.: US 2026/0346338 A1
(43) Pub. Date: Nov. 5, 2026

(54) METHOD FOR MEASURING FOCAL PLANE ERROR IN ADDITIVE MANUFACTURING MACHINES

(71) Applicant: Georgia Tech Research Corporation, Atlanta, GA (US)

(72) Inventors: Jaime Berez, Atlanta, GA (US); Enea Dushaj, Atlanta, GA (US); Elliott Jost, Atlanta, GA (US); Chris Saldana, Atlanta, GA (US)

(21) Appl. No.: 19/488,285

(22) PCT Filed: Jun. 6, 2024
(86) PCT No.: PCT/US2024/032721

§ 371 Date: Nov. 26, 2025

Related U.S. Application Data
(60) Provisional application No. 63/472,124, filed on Jun. 9, 2023.

(51) Int. Cl. B22F 10/80; B22F 10/28; B22F 12/41; B22F 12/49; B22F 12/60; B22F 12/90; B33Y 30/00; B33Y 50/00; G05B 19/418

(52) U.S. Cl. CPC B22F 10/80; B22F 10/28; B22F 12/41; B22F 12/49; B22F 12/60; B22F 12/90; B33Y 30/00; B33Y 50/00; G05B 19/41875; G05B 2219/49023

(57) ABSTRACT

A method of determining focal error in an additive manufacturing system comprising a laser, a recoater configured to apply a feedstock material along a build plane, and an optomechanical system configured to focus a beam generated by the laser to a focal surface proximate the build plane. The method can comprise: for each of a plurality of locations on the build plane: positioning a substrate relative to the build plane at a plurality of z-positions, each z-position corresponding to a unique distance between the build plane and the substrate; at each of the plurality of z-positions, etching a track in the substrate corresponding to the respective location in the plurality of locations on the build plane; for each etched track, determining a width of the corresponding track; and determining, based at least on the determined widths, a focal error for the respective location on the build plane.

### CROSS-REFERENCE TO RELATED APPLICATIONS

This application claims the benefit of U.S. Provisional Application Ser. No. 63/472,124, filed on 9 Jun. 2023, which is incorporated herein by reference in its entirety as if fully set forth below.

### GOVERNMENT LICENSE RIGHTS

This invention was made with government support under Agreement No. DE-EE0008303, awarded by the Department of Energy. The government has certain rights in the invention.

### FIELD OF THE DISCLOSURE

The various embodiments of the present disclosure relate generally to additive manufacturing devices.

### BACKGROUND

Laser powder bed fusion (PBF-LB) is a prevalent form of metal additive manufacturing (AM) with high commercial adoption in the aerospace and medical sector, amongst others. These applications naturally require a high degree of process control, which is a driving force behind the emphasis on research and development in material and component qualification. Good process control also necessitates examination of the operation principles and performance of the AM machine tools themselves. As a broad overview, PBF-LB machine tools utilize a laser(s) to fuse a feedstock powder which is spread over a powder bed in thin layers by a powder spreading device, e.g., a recoater. Solid-state Nd:YAG or Yb-fiber single-mode Gaussian lasers are used in the vast majority of commercially available PBF-LBF systems. Common implementations in commercial machines utilize galvanometer driven mirrors to steer the laser beam through an F-theta scan lens or another type of focusing optic, which focuses the beam onto a nominally planar working field. The laser beam undergoes a converging-diverging behavior as determined by the scan lens, with the point of focus or beam waist, being where the spot size is at a minimum along the beam axis. One major performance characteristic to consider is thus the offset between the focus point of the beam and the powder bed, sometimes referred to as “defocus” or “focus offset” in literature pertaining to AM. Focus offset can be introduced intentionally, but it also may be inherent in the performance a PBF-LB machine, displaying off-nominal characteristics due to factors such as imperfect optical elements, machine construction, set-up or calibration, thermal and environmental factors, and performance drift. As of yet, there has been very little study of either these potential errors or suitable measurement methods for capturing them.

The motivation to develop appropriate methods for measuring laser defocus in PBF-LB is clear if one considers that defocus leads to fundamental changes in energy input to the process zone. Prior work has shown that a defocused beam in the PBF-LB process can produce lowered beam intensity and changes in welding mode, leading to decreases in melt pool depth, microstructural coarsening, variations in porosity formation, and improved surface texture. Various results also indicate that negative defocus, i.e., with the beam waist below the substrate, produces deeper melt pools than equivalent levels of positive defocus, attributed to the converging beam increasing laser absorptivity and beam reflections inside the melt pool depression. In summary, it appears that a focus offset of merely ±2-3 mm, if not less, is capable of imparting significant impacts to melt pool depth and welding mode.

Critically, in each of these cases, the methods by which defocus levels were determined have not been extensively detailed, nor has the position within the scan field where the laser was used been clearly stated. Several studies have even commented on potential measurement errors in determining the true beam waist location. As the present disclosure demonstrates, inherent focus offsets of significant levels in PBF-LB machines are both likely present and suspected to be detrimental to the PBF-LB process. This can be quantitatively captured before the process is impacted.

As a general principle, the converging-diverging nature of the beam cross section, also known as the beam caustic, can be measured by gathering spot size measurements along the axis of the beam. Several existing commercial instruments are capable of such measurements and can be broadly categorized as camera-based, wave propagation-based, and diffraction-based instruments. In general, utilizing either for beam caustic measurement on a PBF-LB machine is challenged by cost of the instrument, time to complete a caustic measurement, and potential requisite access to PBF-LB system non-standard controls. Perhaps most importantly, these instruments are not conducive to measurement of the beam caustic over the entire scan field due to sheer instrument size, laborious set-up for each position in the build space, and the inability to measure a beam with a nonzero incidence angle, i.e., at nonzero (x, y) positions. Although some diffraction-based instruments are capable of nonzero incidence angle beam measurement, instrument size is still a limiting factor. In addition to these established approaches, other novel beam measurement methods have been presented in the literature but do not appear to have gained traction. Notably, the inventors are not aware of any examples of focus characterization over the build space as a function of (x,y), likely owing to deficiencies in the currently available methods.

A typical question of many skeptical users of a PBF-LB machine is whether the laser beam is focused at the positioned as intended. The review of prior work suggests this is a worthwhile question, but one lacking the appropriate requisite method to measure the variable in question. Critically, the ability to measure laser focal error (1) on-machine, (2) over the entire build space, and (3) with relative ease and affordability is ideal. These abilities are key to capturing performance limitations inherent to current PBF-LB systems as well as otherwise correctable errors. Further, the ability to easily track PBF-LB machine tool performance while minimizing machine down-time and maintenance cost is paramount in a production environment. In response to these gaps, this disclosure presents novel measurement methods capable of determining the discrepancy between laser focus plane and the build plane, i.e., focal plane error. The method can be high throughput in nature, easily scaled over the build space, and inexpensive.

### BRIEF SUMMARY

An exemplary embodiment of the present disclosure provides a method of determining focal error in an additive manufacturing system. The additive manufacturing system can comprise a laser, a recoater configured to apply a feedstock material along a build plane, and an optomechanical system configured to focus a beam generated by the laser to a focal surface proximate the build plane. The method can comprise: for each of a plurality of locations on the build plane: positioning a substrate relative to the build plane at a plurality of z-positions, each z-position corresponding to a unique distance between the build plane and the substrate; at each of the plurality of z-positions, etching a track in the substrate corresponding to the respective location in the plurality of locations on the build plane; for each etched track, determining a width of the corresponding track; and determining, based at least on the determined widths, a focal error for the respective location on the build plane.

In any of the embodiments disclosed herein, the width can be an average width.

In any of the embodiments disclosed herein, the additive manufacturing system can be a laser powder bed fusion (LPBF or PBF-LB) additive manufacturing system.

In any of the embodiments disclosed herein, the laser can be configured to deliver a linear energy density of 0.06-0.1 W-s/mm, which can be optimal for ablation of a substrate which is anodized aluminum.

In any of the embodiments disclosed herein, each of the etched tracks can be substantially linear.

In any of the embodiments disclosed herein, the build plane can be parallel and coincident to a powder bed as formed by the recoater and can have an origin corresponding to a position directly beneath a center of a lens of the optomechanical system, and each of the plurality of etched tracks that does not pass through the origin can comprise a first end and a second end, in which the second end can extend from the first end in a direction directly away from the origin.

In any of the embodiments disclosed herein, each of the etched tracks can be curved.

In any of the embodiments disclosed herein, each of the etched tracks can be circular.

In any of the embodiments disclosed herein, the method can further comprise generating a map indicative of the determined focal errors at each of the plurality of locations on the build plane.

In any of the embodiments disclosed herein, determining the focal error for the respective location can comprise: generating a plot of the width of each track at the plurality of z-positions; curve-fitting the plot to generate a track width curve; and determining a minimum of the track width curve, wherein the focal error for the respective location can be based on a z-position corresponding to a minimum track width on the track width curve.

In any of the embodiments disclosed herein, the track width curve can be hyperbolic.

In any of the embodiments disclosed herein, the method can further comprise generating a data set indicative of the focal error at each of the plurality of locations.

In any of the embodiments disclosed herein, the etched tracks can be non-linear, and the method can further comprise determining, based on one or more of the etched tracks at the plurality of locations, a shape of the beam at the plurality of locations.

In any of the embodiments disclosed herein, the method can further comprise determining, based on a shape of one or more of the etched tracks, one or more parameters associated with a beam steering system of the additive manufacturing system.

In any of the embodiments disclosed herein, the substrate can comprise a coating, and the coating and substrate can form at least one coupon.

In any of the embodiments disclosed herein, the at least one coupon can be an anodized aluminum coupon.

Another embodiment of the present disclosure provides a system for determining focal error in an additive manufacturing system. The additive manufacturing system can comprise a laser, a recoater configured to apply a feedstock material along a build plane, and an optomechanical system configured to focus a beam generated by the laser to a focal surface proximate the build plane. The system can comprise at least one memory and at least one processor. The at least one memory can comprise instructions that, when executed by the at least one processor, cause the at least one processor to: for each of a plurality of locations on the build plane: position a substrate relative to the build plane at a plurality of z-positions, each z-position corresponding to a unique distance between the substrate and the build plane; at each of the plurality of z-positions, etch a track in the substrate corresponding to the respective location in the plurality of locations on the build plane; for each etched track, determine a width of the corresponding track; and determine, based at least on the determined widths, a focal error for the respective location on the build plane.

In any of the embodiments disclosed herein, the at least one memory can further comprise instructions that, when executed by the at least one processor, cause the at least one processor to generate a map indicative of the determined focal errors at each of the plurality of locations on the build plane.

In any of the embodiments disclosed herein, the at least one memory can further comprise instructions that, when executed by the at least one processor, cause the at least one processor to determine the focal error for the respective location by performing at least the following steps: generating a plot of the width of each track at the plurality of z-positions; curve-fitting the plot to generate a track width curve; and determining a minimum of the track width curve, wherein the focal error for the respective location is based on a z-position corresponding to a minimum track width on the track width curve.

In any of the embodiments disclosed herein, the at least one memory can further comprise instructions that, when executed by the at least one processor, cause the at least one processor to generate a data set indicative of the focal error at each of the plurality of locations.

In any of the embodiments disclosed herein, the etched tracks can be non-linear, and the at least one memory can further comprise instructions that, when executed by the at least one processor, cause the at least one processor to determine, based on one or more of the etched tracks at the plurality of locations, a shape of the beam at the plurality of locations.

In any of the embodiments disclosed herein, the at least one memory can further comprise instructions that, when executed by the at least one processor, cause the at least one processor to determine, based on a shape of one or more of the etched track, one or more parameters associated with a beam steering system of the additive manufacturing system.

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF THE DRAWINGS

The following detailed description of specific embodiments of the disclosure will be better understood when read in conjunction with the appended drawings. For the purpose of illustrating the disclosure, specific embodiments are shown in the drawings. It should be understood, however, that the disclosure is not limited to the precise arrangements and instrumentalities of the embodiments shown in the drawings.

FIG. 1A provides an additive manufacturing system, in accordance with some embodiments of the present disclosure.

FIG. 1B provides a visualization of focal plane error.

FIG. 2 provides a visualization of a theoretical beam caustic.

FIG. 3 provides a 3-D visualization of programmed laser scan paths for a coupon located at (x,y)=(0,0), in which the z-axis corresponds to the build direction.

FIG. 4 provides a visualization of track directions as a function of build area location (Note: tracks are not to scale and only four are shown for legibility, but an individual coupon with 25 tracks is shown on the right).

FIGS. 5A-D provide visualization of workflow for ablated track width measurement.

FIG. 5A illustrates a single coupon originating from (x,y)=(0,0).

FIG. 5B provides details of tracks ablated at varying z heights.

FIG. 5C provides details of a single ablated track showing a portion of the determined edges, centerline, and every 50^{th} width measurement.

FIG. 5D provides a distribution of width measurements along a single track.

FIG. 6 provides a plot of typical track width measurements, caustic fitting, and minima extraction for focal point error (Note that the theoretical caustic is shifted in z by 0.75 mm), in accordance with some embodiments of the present disclosure.

FIG. 7A provides a plot of focal plane error measurements over the build space, and

FIG. 7B provides a 3D visualization of focal plane error, in accordance with some embodiments of the present disclosure.

FIG. 8A provides a plot of focal plane error measurements over the build space, and

FIG. 8B provides a 3D visualization of focal plane error, in accordance with some embodiments of the present disclosure.

FIG. 9A provides a plot of measured focal plane of experiment 1 subtracted from the measured focal plane of experiment 2 and reference measurement of the build platform tilt introduced between experiments 1 and 2.

FIG. 9B illustrates error between the difference of experiments 1 and 2 relative to the reference plane.

### DETAILED DESCRIPTION

To facilitate an understanding of the principles and features of the present disclosure, various illustrative embodiments are explained below. The components, steps, and materials described hereinafter as making up various elements of the embodiments disclosed herein are intended to be illustrative and not restrictive. Many suitable components, steps, and materials that would perform the same or similar functions as the components, steps, and materials described herein are intended to be embraced within the scope of the disclosure. Such other components, steps, and materials not described herein can include, but are not limited to, similar components or steps that are developed after development of the embodiments disclosed herein.

To understand certain embodiments disclosed herein, the present disclosure refers to certain phrases throughout, which can have the following meanings. Build plane: An ideal geometrical element associated with the powder bed surface as established by a recoating mechanism (e.g., recoater) establishing z=0 (z-position=0). Discussion: The build plane, a theoretically perfect plane, models the surface of the powder bed, a nominally planar feature with form error. The form error of the powder bed, and any potential error in establishing the build plane as a reference feature, is considered negligible in the context of this disclosure. Focal plane/surface: A surface, over which the laser beam is in focus, i.e., where the spot size is at a minimum. Focal plane error: The focal plane in relation to the build plane, valued in the z direction and defined as a function of build coordinates x and y, where z=0 is defined by the build plane.

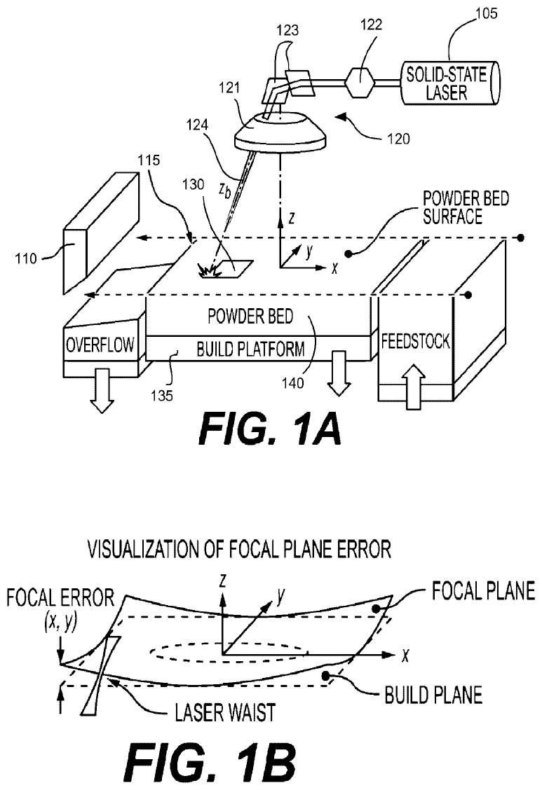

Embodiments of the present disclosure provide systems and methods for determining focal error inherent in certain additive manufacturing (AM) systems, such as laser powder bed fusion (LPBF or PBF-LB) additive manufacturing systems. As shown in FIG. 1A, an AM system can comprise a laser 105, a recoater 110, an optomechanical system 120, and a build platform 135. A powder bed 140 is typically located on the build platform 135. The laser 105 can generate a beam 124, which can be directed towards a build plane 115 by an optomechanical system. The build plane can generally be defined as an ideal geometrical element associated with the powder bed surface as established by a powder spreading device, establishing z=0. The beam can ablate a portion of the powder feedstock material on the powder bed to form various shapes. Each time a layer of the feedstock is ablated, the recoater can recoat the top surface of the powder bed with a new layer of feedstock material.

The optomechanical system 120 can comprise one or more lenses 121 and other optical elements, such as a beam expander 122 and beam steering mirrors 123. The optomechanical system can be configured to focus the beam along a focal surface proximate the build plane. The focal surface can generally be defined as a surface over which the laser beam is in focus, i.e., where the spot size is at a minimum. Though the focal surface is sometimes referred to as a “focal plane,” in effect, the surface is rarely, if ever, planar. Rather, as shown in FIG. 1B, the focal surface can have varying levels of curvature and/or tilt and/or offset relative to the build plane. In an ideal AM system, the focal surface would be co-planar with the build plane. But as shown in FIG. 1B, this is not typically the case in AM systems. Rather, there is some “focal error” distance in the vertical z-direction between the focal surface and the build plane at various x-y locations along the build plane. This focal error can negatively impact the performance of the system. It would be advantageous to know the focal error between the focal surface and build plane and each x-y position along the build plane. If the focal error is known, the vertical positions of the build platform relative to the lens 121 (or another component) can be altered for each x-y location to ensure the beam is focused at that particular location prior to ablation. Accordingly, embodiments of the present disclosure provide systems and methods for determining this focal error.

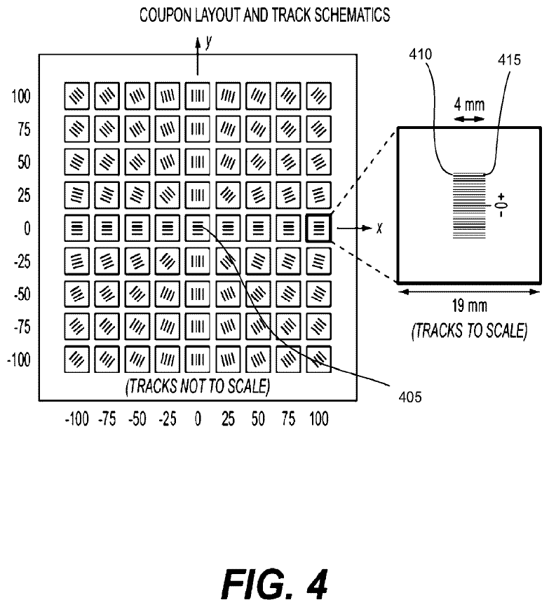

Another exemplary embodiment of the present disclosure provides a method of determining focal error in an additive manufacturing system. The method can comprise, for each of a plurality of locations (i.e., x-y locations) on the build plane, positioning a substrate 130 relative to the build plane at a plurality of z-positions. The substrate 130 can be positioned on a top surface of the powder bed 140 or build platform 135. Each z-position can correspond to a unique distance between the build plane 115 and the substrate 130. The substrate 130 can be positioned relative to the build plane 115 at the plurality of z-positions, for example, by varying the height of the build platform 135 upon which the substrate 130 can be located. The substrate 130 can be many different substrates known in the art. In some embodiments, the substrate 130 can comprise a coating forming a coupon, such as an anodized aluminum coupon. In some embodiments, the substrate can comprise a coupon located at each of the plurality of locations along the build plane 115, as shown in FIGS. 4B-C.

The method can further comprise, at each of the plurality of z-positions, etching a track in the substrate corresponding to the respective location in the plurality of locations on the build plane. In other words, at a first z-position (i.e., first distance between the build plane and the substrate), a first track can be etched in a coupon. The build platform can then be adjusted up or down to a second z-position (i.e., second distance between the build plane and the substrate), and a second track can be etched into the substrate (can be the same or a different substrate that the first track was etched into). This can be repeated at a plurality of z-positions.

The inventors have determined that the energy density delivered by the laser can effect the performance of the methods disclosed herein. Accordingly, in some embodiments, the laser can be configured to deliver a linear energy density of 0.06-0.1 W-s/mm. This can be advantageous for ablation of anodized aluminum substrates. The present disclosure, however, is not so limited. Rather, as those skilled in the art would understand, the laser can deliver a variety of energy densities or ranges thereof in various embodiments.

The etched tracks can have many shapes in accordance with various embodiments of the present disclosure, including, but not limited to, linear, curved, circular, and the like. In some embodiments, the tracks can extend in different directions. For example, as shown in FIG. 4C, the build plane can have an origin corresponding to a position directly beneath a center of a lens of the optomechanical system, which can be represented by the x-y coordinates (0,0). For certain coupons that are not located at the origin, (coupon 405), each of the plurality of etched tracks can comprise a first end 410 and a second end 415, in which the second end can extend from the first end in a direction directly away from the origin.

In some embodiments, the etched tracks can be non-linear, and the method can further comprise determining, based on one or more of the etched tracks at the plurality of locations, a shape of the beam at the plurality of locations. Additionally, in some embodiments, the method can further comprise determining, based on a shape of one or more of the etched tracks, one or more parameters associated with a beam steering system of the additive manufacturing system.

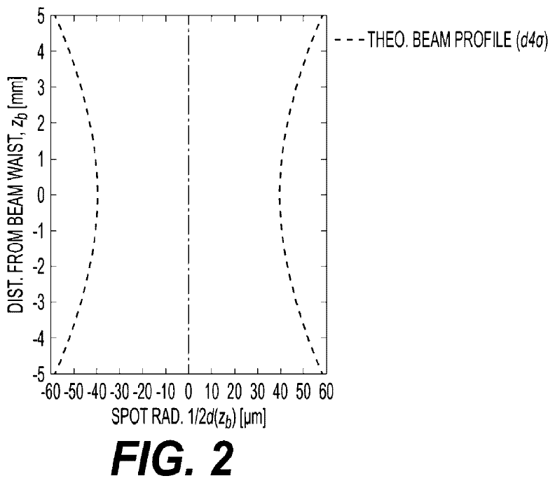

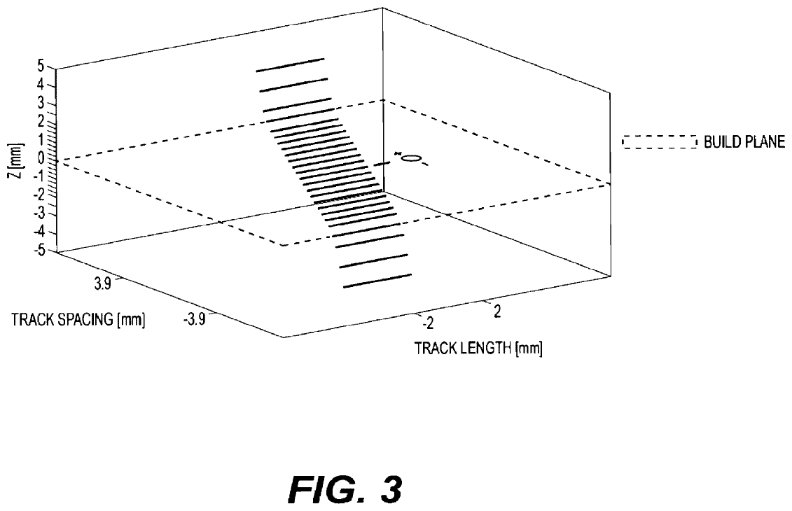

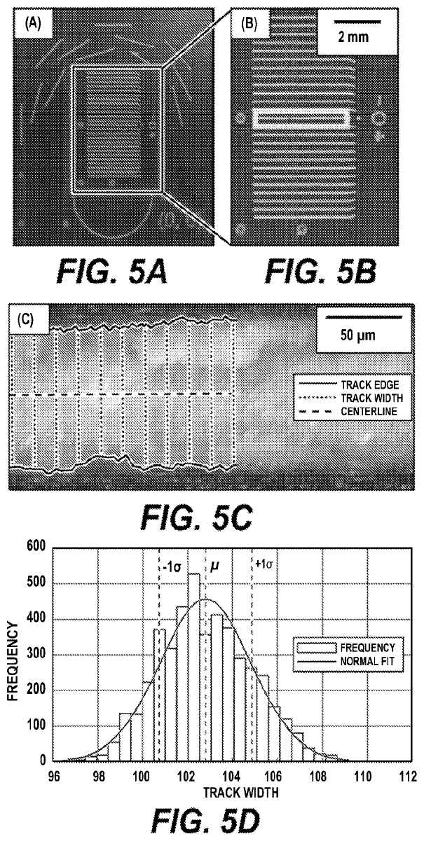

As a result of the shape of the beam caustic, as shown in FIG. 2, each of the tracks can have varying widths at each z-position. Accordingly, the method can further comprise, for each etched track, determining a width of the corresponding track. In some embodiments, the width can be determined to be the average width of the corresponding track. FIGS. 5A-D illustrate how each coupon can contain multiple tracks for each z-position, in which the tracks have varying widths (FIG. 5D).

The track having the narrowest width (or average width) can correspond to the z-position where the beam is the most focused. Accordingly, the method can further comprise determining, based at least on the determined widths, a focal error for the respective location on the build plane. For example, in some embodiments, determining the focal error for the respective location on the build plane can comprise: generating a plot of the width of each track at the plurality of z-positions; curve-fitting the plot to generate a track width curve; and determining a minimum of the track width curve. In such embodiments, the focal error for the respective location can be based on a z-position corresponding to a minimum track width on the track width curve

For example, consider the scenario where the track with the smallest width at a particular x-y location on the build plane 115 corresponds to a z-position 1.5 mm above the build plane 115, then a focal error for that particular x-y location can be +1.5 mm (focal error can be positive or negative, i.e., above or below the build plane). Accordingly, to achieve more uniform and precise ablation at that particular x-y location, for example, the build platform can be lowered 1.5 mm when ablation at that particular x-y location is desired.

In some embodiments, the method can further comprise generating a map indicative of the determined focal errors at each of the plurality of locations on the build plane. For example, the map can comprise a set of data providing the determined focal error for each of the plurality of locations along the build plane.

Though embodiments herein are discussed in the context of a laser powder bed fusion (LPBF or PBF-LB) additive manufacturing system, the disclosure is not so limited. Rather, embodiments of the present disclosure can apply to other AM systems, including, but not limited to, selective laser sintering (SLS) systems, powder bed fusion electron beam (PBF-EB) systems, and the like.

### EXAMPLES

The discussion below is provided to illustrate certain exemplary embodiments of the present disclosure. This discussion, however, is exemplary only and should not be construed as limiting the scope of the present disclosure or the claims appended hereto.

### Materials and Methods

### PBF-LB Optomechanical System

Measurements of laser focus over the build space of a commercial EOS M280 PBF-LB machine tool were performed. This PBF-LB system utilizes a single-mode Gaussian 400 W Yb-fiber laser (wavelength 2=1064 nm) to selectively fuse material over a 250×250 mm build space (x and y dimensions). FIG. 1A shows a graphical description of the system, with certain characteristics noted. A brief description of the optomechanical system is provided here. A columnated laser is directed via a fiber optic to a beam expander, which defines the beam entrance diameter, dₑₙₜ, to the subsequent scan system. The beam is steered by two galvanometer driven mirrors through an F-theta scan lens and a cover lens. The F-theta optic focuses the beam onto a nominally flat focal plane and has a focal length reported as f=410 mm by the AM machine tool manufacturer. No other specifications of the optical element were reported by the AM machine tool manufacturer and none were available in any product literature of the lens manufacturer nor in the peer-reviewed body of work. Nominally, the PBF-LB system is intended to focus the laser beam onto a focal plane/focal surface, which exists in relation to a build plane, abstractly depicted in FIG. 1B. Focal error can then be described as the difference between the focal plane/surface relative to the build plane.

Note that in the examined PBF-LB machine tool, the powder bed is formed by a recoating mechanism that translates a straight edge, aligned in they direction, in the −x direction over a straight path, seen in FIG. 1A. Recoating mechanisms, however, can vary in commercial implementations.

The phenomena of beam focus at any (x, y) position can be captured by the concept of a beam caustic, which expresses the beam spot size as a function of position along the beam travel direction, z_{b}. FIG. 2 shows the beam caustic for the assessed PBF-LB system, calculated using the formulae below. Equation (1) defines the focused beam spot size, d₀. Here, dₑₙₜ is the beam entrance diameter and M² is the beam quality factor, where M²=1.0 indicates ideal divergence behavior for a Gaussian beam. Equation (2) defines the Rayleigh length of the beam, z_{R}, indicating the distance over which the beam spot size doubles in area. Finally, Equation (3) defines the beam spot size, d, as a function of z_{b}, i.e., the beam caustic. Note that there exist numerous methods for expressing the spot size of Gaussian beams—here, d₀ and all other references to spot size correspond to the D4σ definition, which corresponds to 4 times the standard deviation, σ, of the beam intensity distribution, i.e., ±2σ. Additionally, note that M² is taken as 1.0 and dₑₙₜ as 7.0 mm, based on measurements conducted by the inventors on a highly similar EOS M290 PBF-LB system which indicated that M² is close to 1.0 and the focused spot size is 80 μm (used to back-calculate dent).

$${d}_{0} = 2 {ω}_{0} = \frac{4 {M}^{2} λ f}{π {d}_{ent}} \qquad Equation 1$$

$${z}_{R} = \frac{π {d}_{0}^{2}}{4 {M}^{2} λ} \qquad Equation 2$$

$$d ( {z}_{b} ) = {d}_{0} \sqrt{1 + {( \frac{{z}_{b}}{{z}_{R}} )}^{2}} \qquad Equation 3$$

### Laser Focal Error Measurement Method

This disclosure can employ a novel artifact-based method of beam caustic measurement. The PBF-LB system laser can be used to ablate the anodized coating on aluminum coupons in a controlled manner. To demonstrate the principle, consider a single coupon positioned at (x, y)=(0, 0) (origin). Ablated tracks were formed by single laser scan paths over the coupon. Tracks were ablated at various offsets (z-positions) between the coupon top surface and the known build plane position, z=0. Each of these z-positions can correspond to a unique distance between the focal lens and the build plane (which alters a vertical position of the focal plane). As the width of these tracks are expected to reflect the beam spot size at each z position, these widths represent a proxy of the beam caustic and can be used to determine the laser focal error at any (x, y) position in the PBF-LB machine tool coordinate system. This approach can be replicated at many (x, y) positions, at a desired level of granularity, thereby determining focal plane error.

Coupons were polished 6061-T6 aluminum, 6.35±0.05 mm thick, 19×19 mm in their footprint, and anodized (type II) black as per MIL-A-8625. Coupons were positioned over the 250×250 mm build space using a fixture that allowed coupons to be arrayed in a gridded pattern at known (x, y) positions in 25 mm intervals. FIG. 2 shows the laser tool paths on the substrate represented in the static build coordinate system. Each track was ablated at a distinct z offset relative to the build plane ranging between −5.0 to z=−5.0 mm. These z values were chosen to be approximately within ±1 Rayleigh length of z=0. Tracks were 4.0 mm long.

To conduct a measurement of a beam caustic using a coupon, the following procedures were followed. (1) The build platform was made parallel to and coincident with the build plane. This can comprise adjusting a kinematic leveling system for the build platform to achieve parallelism to a reference surface on the recoater, verified by measurement with a dial indicator and feeler gages. The physical surface of the build platform was measured to be parallel to and coincident with the build plane to within 50-100 μm after this procedure. (2) Material coupons were placed at desired locations on the build platform. (3) The build platform z position was adjusted to compensate for the thickness of the material coupons and additionally incremented upwards by 5.00 mm. As such, “building,” i.e., laser ablation of the coupons, would begin with the top of the material coupons located at z=5.00 mm. (4) A build file, containing the tracks at all z positions for all coupons was executed.

All tracks were ablated (i.e., etched) using a laser power of P=150 W and laser speed of V=2000 mm/s. During a “build,” the PBF-LB machine tool automatically increments the build platform in the −z direction, pausing for a “layer” to expose coupons to the laser as defined by the build file. This approach means that an extremely large number of material coupons representing many (x, y) coordinates can be processed in a single build sequence lasting approximately 15-30 minutes, including build start/stop procedures.

A Leica DVM6 Digital Microscope was used to obtain a monochromatic image of each 4 mm ablated track approximately at the center of the track. A mid-magnification objective lens with a total FOV of 12.55 mm was used with a magnification of 500×. The pixel side length for each image is 0.168 μm. Each track image was binarized using Otsu's method. The boundaries of the track in the binarized image were determined. An orthogonal least squares fit was applied to each edge of the track using the (x, y) coordinates of the corresponding pixels. At each pixel along one edge, the point on the opposing edge that creates a line segment with a slope orthogonal to the centerline was used to make one width measurement. These measurement lines are shown in the exemplar image in FIG. 5C. Each width measurement in pixels was converted to a physical length measurement. Approximately 3000 width measurements were made for each track. A mean and standard deviation for the width of each track was calculated. This process was repeated for each etched track on each coupon.

### Results

### Measurement of a Typical Coupon

FIG. 5 shows the process by which track width measurements were made, with a coupon located at (x, y)=(0, 0) used as an example of a typical measurement process. Due to the irregularity of the track edges, width measurements vary over the length of the track. FIG. 5 shows an example of width measurement, with ever 50th point of width measurement noted as a dashed line. Widths values were approximately normally distributed as shown in FIG. 5(d), with a typical standard deviation on the order of 3 μm.

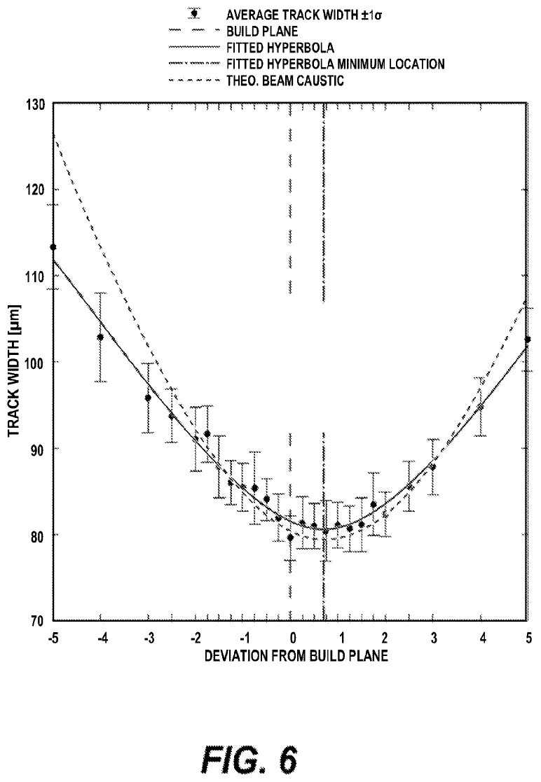

FIG. 6 shows track width measurements from a single coupon. Track width shows a trend reflecting the converging-diverging behavior of the laser beam, with a global minimum contained withing the z domain investigated. Error bars describe the variation in width displayed by each track, as ±16. These values are well above the resolved pixel size of the micrographs acquired, indicating that natural process variation is the major contributor. As first-principles describe a hyperbolic trend in spot diameter as a function of z_{b}, see equation (3), a hyperbolic fit was applied to the average track width, wₜ, as a function of the offset from the build plane, z, for each coupon. Fitting was performed via a Nelder-Mead simplex algorithm. The fitted hyperbola models the empirical data well, as seen via solid curve in FIG. 6. For reference, the theoretical beam caustic, earlier presented in FIG. 2, is also provided in dashed line. It has been shifted by 0.75 mm, to account for the focus error apparent in the experimentally measured beam caustic. There is fair agreement between the fit and theoretical hyperbolas, with highly similar vertex values but a slightly steeper slope towards the asymptotes. This may be explained by the decrease in energy intensity of the spot that comes with beam defocus, leading to ablation scaling less directly with theoretical spot size further away from the beam waist. Further examination of the theoretical relationship between ablated track width and spot size may be warranted. The z value of the minima of the hyperbolic fit was considered the focal error for the (x, y) position of a given coupon.

### Focal Plane/Surface Determination—Flatness, Orientation, and Position

Two independent experiments were conducted to measure focal error in the examined PBF-LB machine tool. The first was intended to assess any inherent errors present when following all best practices in build setup. In other words, the build platform was made parallel with and coincident to the build plane (as defined by the recoater) as nearly as was achievable, as described above. As such, this first experiment assessed focal plane error for the PBF-LB machine in a state as delivered by the machine tool manufacturer and including all performance impacts suffered since in operation. In other words, the machine was representative of an in-service condition. The second experiment was intended to enable comparison between the focal plane measurement method and an arbitrary but measurable tilt (rotation about the x and y axes) introduced to the build platform. In other words, given an initial state (experiment #1) and a final state (experiment #2) with a known disturbance, i.e., build platform tilt, applied between the two, the aim was to assess if this disturbance was accurately measured.

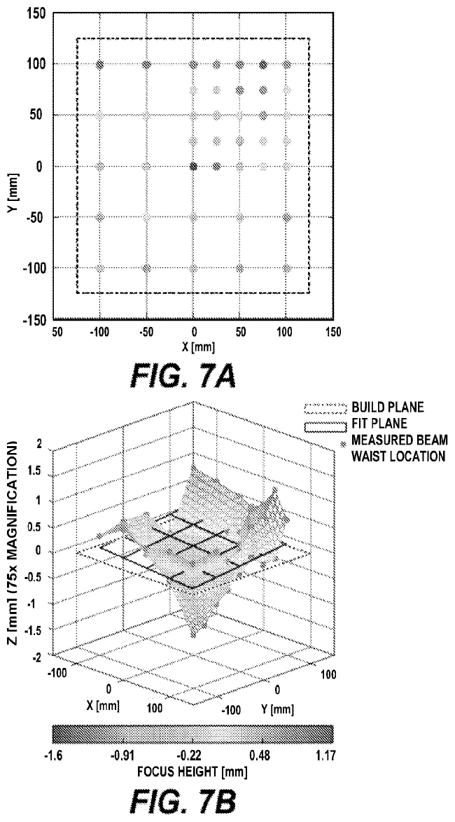

For experiment #1, the procedures detailed above were followed to produce 41 coupons over the build space. Coupons were positioned at 25 mm intervals in the +x/+y quadrant and 50 mm intervals elsewhere to provide a relatively high density of measurements while balancing experimental effort, under the assumption that errors would show mirror symmetry about the x and y axes. After processing all coupons as detailed above, the focal plane error was determined and is displayed in FIG. 7. Focal error values are plotted over the nominal (x, y) locations of each coupon track pattern. The measured focal plane error ranges from −1.60 mm to 1.17 mm. Note that the method employed enabled measurements of focal error to within 25 mm of the boundaries of the build space, indicated by the dashed line in subsequent figures. As is evident, the focal plane exhibited what may be considered form or flatness error, more commonly termed field sag in optical literature. The total variation of focal error at the measured points was 2.77 mm. Investigation of focal plane error even nearer to the build space bounds would have likely revealed even more severe error. As can be seen in FIG. 7B, a plane was fitted to the data via least-squares routine to minimize deviations in z. This plane exhibited parallelism of 0.37 mm relative to the build plane. Parallelism, here, is used in the sense of the term as defined in geometric dimensioning and tolerancing contexts, e.g., ASME Y14.5. It is calculated as the difference between the maximum and minimum distance between the associated (fitted) focal plane and the build plane, over the area measured.

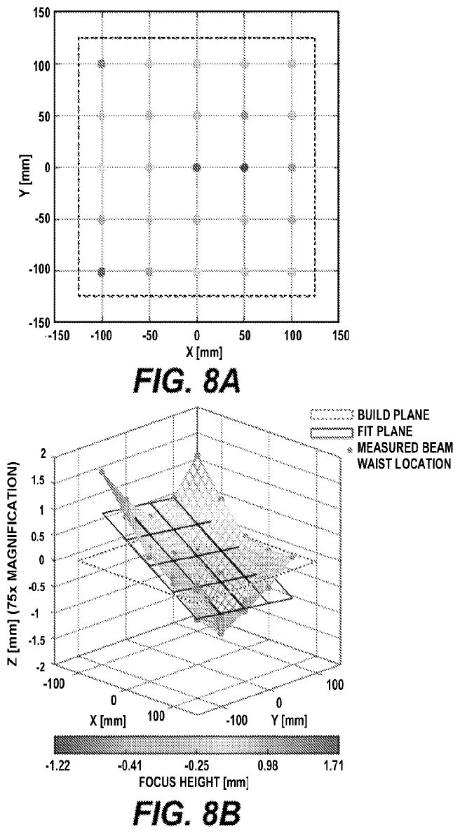

In experiment #2, the build platform leveling mechanism was used to introduce an arbitrary but measurable tilt about the x and y axes—1.67 mm of parallelism error to the build plane. This also simulated the characteristics of a poorly constructed or calibrated machine tool. Dial gauge indicator measurements were used to obtain parallelism measurements between the recoater and build platform, i.e., the change in the build platform orientation between experiment #1 and #2. The “build” was then conducted with laser ablation of 25 coupons over the build space, arranged to investigate the focal plane at 50 mm intervals. After processing all coupons as detailed above, the focal plane error was determined, displayed in FIG. 8. The measured focal plane error ranged from −1.22 to 1.71 mm. The total variation of focal error the measured points was 2.93 mm. As can be seen in FIG. 8B, a plane was fitted to the data via least-squares routine to minimize deviations in z. This plane exhibited parallelism of 1.63 mm relative to the build plane.

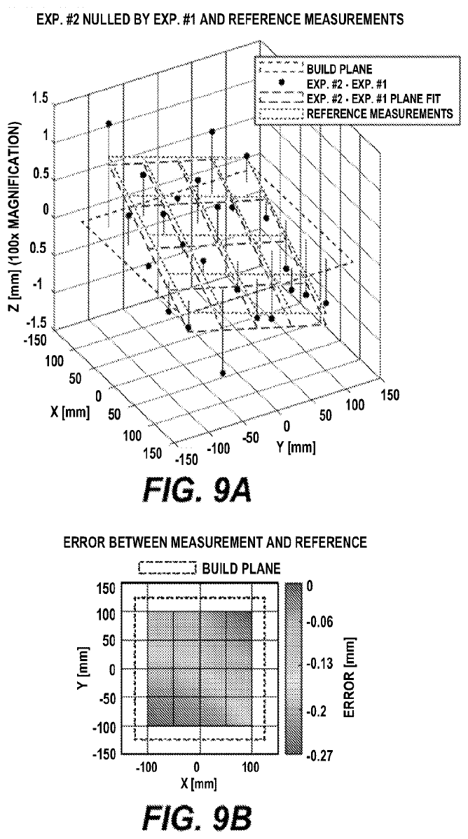

As alluded to above, it is possible to partially verify the accuracy of the measurement method through a comparison of the presented measurements to a known quantity. Although the state of the focal plane in experiment #1 is not known via an independently verifiable method, a known change was introduced and the initial and final states were captured by experiments #1 and #2, respectively. Consider that prior to experiment #1, the build platform was made parallel and coincident to the build plane over the build space, as was detailed above. Now consider that prior to experiment #2, the build platform was intentionally tilted and this was measured via a dial indicator, measuring the displacement of the build platform at each location where a coupon was to be ablated. This produced an array of reference values over the (x, y) domain of the build space. The results of experiment #2, nulled by experiment #1, should then ideally match the reference measurement. FIG. 9 presents this concept quantitatively. The points represent the focal plane error measurements of experiment #1 minus those of experiment #2. The red plane was then fitted to this data. The blue plane represents the known tilt introduced between these two measurements, as measured via the dial indicator. The fit plane and the reference measurements show good agreement, with differences only ranging from 0 to 0.25 mm over the measured build area.

### Discussion

The measurements of focal plane error performed provide novel insight into the performance of a typical PBF-LB commercial system. Considering the results of experiment #1, focal error displays approximate mirror symmetry about the x and y axes, to be expected in systems with typical F-theta optics. This error can be characterized as a bowl-shaped focal plane, with a low point at (x, y)=(0, 0) and more positive focal error trending radially outwards. The focal plane was quite parallel to the build plane; the plane fit to the focal surface displayed 0.37 mm parallelism to the build plane. However, the total variation in focal error over the measured build space, 2.77 mm, was significant due to the form of the focal plane. As was presented in earlier, prior work has found significant changes in the PBF-LB process (melt pool depth, microstructure, porosity, surface roughness) over focus offsets similar in magnitude to these errors, albeit without a prior measurement of focal error provided. The results of experiment #1 also show that, in a typically set-up PBF-LB machine tool, both negative and positive defocus can be present, which may create impacts to the process.

The results of experiment #2 show further applications for the novel measurement method. Poor optical element installation could result in a focal plane with poor parallelism relative to the build plane. Conversely, poor recoater system setup (such as incorrect blade installation) or mechanical disturbances and wear in the assembly (such as from recoater crashes) could produce the same net result. Experiment #2 simulated such a scenario, capturing a focal plane with parallelism to the build plane of 1.63 mm.

The disclosure herein suggests that a reexamination of laser focus offset as a process parameter. While the prior works provided insight into the process impacts of focus offset in PBF-LB, the conclusions of these results should be tempered by the lack of an appropriate concurrent focal error measurement method, which was not available. Similarly, significant efforts have been recently aimed at understanding variable microstructure, defect content, and mechanical properties over the build space. Various authors have speculated on the impact of a variety of candidate process issues including shielding gas flow, spatter, laser attenuation by condensate clouds, and variable laser spot size, shape, and intensity. The novel measurement presented herein is an important and enabling tool which can now be aimed at understanding the contributions of these critical variables.

The novel method for focal plane error measurement presented here plainly has several advantages over existing methods. With relatively minor experimental effort and expense, focal plane error was measured over nearly the entire build space at a fine level of granularity, up to 25 mm increments in x/y. The novel approach used inexpensive and commonly available coupon material, a fixture, and one build file to be executed by the PBF-LB system. While the subsequent microscopy measurements are currently labor intensive and require custom software to process, these aspects of the process are amenable to automation. Overall, this method enabled a focal plane error measurement not yet realized in the prior art. It also revealed that typical focal errors in PBF-LB machine tools, on the order of 2-3 mm over the build space, are significant in terms of process impacts. While optical system manufacturers certainly are capable of simulating and verifying characteristics like field sag at a high spatial density with low uncertainty, these principles are limited in their application to the PBF-LB machine tool, where on-machine performance testing can be critical to capturing the state of the machine tool as a function of many factors.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way.

1. A method of determining focal error in an additive manufacturing system comprising:
for each location on a build plane:
positioning a substrate relative to the build plane at z-positions, each z-position corresponding to a unique distance between the build plane and the substrate;
at each of the z-positions, etching a track in the substrate corresponding to the respective location on the build plane;
for each etched track, determining a width of the respective track; and
determining, based at least on the determined widths, a focal error for the respective location on the build plane.

2. The method of claim 1, wherein the width is an average width.

3. The method of claim 1, wherein the additive manufacturing system is a laser powder bed fusion (LPBF or PBF-LB) additive manufacturing system.

4. The method of claim 1, wherein a laser of the additive manufacturing system is configured to deliver a linear energy density of 0.06-0.1 W-s/mm.

5. The method of claim 1, wherein a shape of each of the etched tracks is selected from a group consisting of substantially linear, curved, and circular.

6. The method of claim 5, wherein:
the build plane is parallel and coincident to a powder bed as formed by a recoater of the additive manufacturing system and has an origin corresponding to a position directly beneath a center of a lens of an optomechanical system of the additive manufacturing system; and
each etched track that does not pass through the origin comprises a first end and a second end, the second end extending from the first end in a direction directly away from the origin.

7-8. (canceled)

9. The method of claim 1 further comprising at least one of:
generating a map indicative of the determined focal errors at each of the locations on the build plane;
generating a data set indicative of the focal error at each location;
determining, based on a shape of one or more of the etched tracks, one or more parameters associated with a beam steering system of the additive manufacturing system; or
determining, based on one or more of the etched tracks, a shape of a beam generated by a laser of the additive manufacturing system to a focal surface proximate the build plane at the locations.

10. The method of claim 1, wherein the determining comprises:
generating a plot of the width of each track at the z-positions;
curve-fitting the plot to generate a track width curve; and
determining a minimum of the track width curve;
wherein the focal error for the respective location is based on a z-position corresponding to a minimum track width on the track width curve.

11. The method of claim 10, wherein the track width curve is hyperbolic.

12. The method of claim 1, wherein the additive manufacturing system comprises:
a laser;
a recoater configured to apply a feedstock material along the build plane; and
an optomechanical system configured to focus a beam generated by the laser to a focal surface proximate the build plane; and
at least one of:
the width is an average width;
the additive manufacturing system is a laser powder bed fusion (LPBF or PBF-LB) additive manufacturing system;
the laser is configured to deliver a linear energy density of 0.06-0.1 W-s/mm;
a shape of each of the etched tracks is selected from a group consisting of substantially linear, curved, and circular;
the build plane is parallel and coincident to a powder bed as formed by the recoater and has an origin corresponding to a position directly beneath a center of a lens of the optomechanical system, where each etched track that does not pass through the origin comprises a first end and a second end, the second end extending from the first end in a direction directly away from the origin;
the determining comprises generating a plot of the width of each track at the z-positions, curve-fitting the plot to generate a track width curve, and determining a minimum of the track width curve, where the focal error for the respective location is based on a z-position corresponding to a minimum track width on the track width curve;
the substrate comprises a coating, the coating and substrate forming at least one coupon;
the substrate comprises a coating, the coating and substrate forming at least one anodized aluminum coupon;
the method further comprises generating a data set indicative of the focal error at each location;
the method further comprises generating a map indicative of the determined focal errors at each of the locations on the build plane;
the method further comprises determining, based on a shape of one or more of the etched tracks, one or more parameters associated with a beam steering system of the additive manufacturing system; or
the method further comprises determining, based on one or more of the etched tracks, a shape of a beam generated by a laser of the additive manufacturing system to a focal surface proximate the build plane at the locations.

13-16. (canceled)

17. A system for determining focal error in an additive manufacturing system comprising:
at least one memory and at least one processor, the at least one memory comprising instructions that, when executed by the at least one processor, cause the at least one processor to:
for each location on a build plane:
position a substrate relative to the build plane at z-positions, each z-position corresponding to a unique distance between the substrate and the build plane;
at each z-positions, etch a track in the substrate corresponding to the respective location on the build plane;
for each etched track, determine a width of the respective track; and
determine, based at least on the determined widths, a focal error for the respective location on the build plane.

18. (canceled)

19. The system of claim 17, wherein the additive manufacturing system is a laser powder bed fusion (LPBF or PBF-LB) additive manufacturing system.

20. The system of claim 17, wherein the laser is configured to deliver a linear energy density of 0.06-0.1 W-s/mm.

21.-24. (canceled)

25. The system of claim 17, wherein the at least one memory further comprises instructions that, when executed by the at least one processor, cause the at least one processor to generate a map indicative of the determined focal errors at each of the locations on the build plane.

26. The system of claim 17, wherein the at least one memory further comprises instructions that, when executed by the at least one processor, cause the at least one processor to determine the focal error for the respective location by:
generating a plot of the width of each track at the z-positions;
curve-fitting the plot to generate a track width curve; and
determining a minimum of the track width curve;
wherein the focal error for the respective location is based on a z-position corresponding to a minimum track width on the track width curve.

27. (canceled)

28. The system of claim 17, wherein the at least one memory further comprises instructions that, when executed by the at least one processor, cause the at least one processor to generate a data set indicative of the focal error at each of the locations.

29. The system of claim 17, wherein:
the etched tracks are non-linear; and
the at least one memory further comprises instructions that, when executed by the at least one processor, cause the at least one processor to determine, based on one or more of the etched tracks at the locations, a shape of the beam at the locations.

30. The system of claim 17, wherein the at least one memory further comprises instructions that, when executed by the at least one processor, cause the at least one processor to determine, based on a shape of one or more of the etched tracks, one or more parameters associated with a beam steering system of the additive manufacturing system.

31. The system of claim 17, wherein the substrate comprises a coating, the coating and substrate forming at least one anodized aluminum coupon.

32. (canceled)

33. A system comprising:
an additive manufacturing system comprising:
a laser;
a recoater configured to apply a feedstock material along a build plane; and
an optomechanical system configured to focus a beam generated by the laser to a focal surface proximate the build plane;
at least one memory; and
at least one processor;
wherein at least one of the memory comprising instructions that, when executed by at least one of the processors, cause at least one of the processors to, for each location on the build plane:
position a substrate relative to the build plane at z-positions, each z-position corresponding to a unique distance between the substrate and the build plane;
at each z-positions, etch a track in the substrate corresponding to the respective location on the build plane;
for each etched track, determine a width of the respective track; and
determine, based at least on the determined widths, a focal error for the respective location on the build plane.
